(19) United States
(12) Patent Application Publication
(10) Pub. No.: US 2001/0037205 A1
(43) Pub. Date: Nov. 1, 2001

(54) Apparatus and method for effectuating an affiliated marketing relationship

(76) Inventor: Raymond Anthony Joao, Yonkers, NY (US)

Correspondence Address: RAYMOND A. JOAO, ESQ., 122 BELLEVUE PLACE, YONKERS, NY, 10703, US

(21) Appl. No.: 09/771,491

(22) Filed: Jan. 27, 2001

Related U.S. Application Data
(60) Provisional application No. 60/178,867, filed on Jan. 29, 2000.

(51) Int. Cl. G06F 17/60

(52) U.S. Cl. 705/1; 705/14; 705/38; 705/40; 705/35; 705/39

(57) ABSTRACT

An apparatus and method for effectuating an affiliated marketing relationship, including a receiver for allowing a user to access the apparatus via a content provider computer, a processor for processing a transaction entered into by the user and a merchant associated with the apparatus, wherein the processor identifies the content provider referring the user to the apparatus, and further wherein the processor calculates at least one of a commission and a referral fee due to the content provider, and further wherein the processor generates a transaction notification report containing information regarding the occurrence of the transaction and the at least one of a commission and a referral fee, and a transmitter for transmitting the transaction notification report to a communication device associated with the content provider.

### RELATED APPLICATIONS

This application claims the benefit of priority of U.S. Provisional Patent Application Serial No. 60/178,867, filed Jan. 29, 2000, which teaches and discloses an apparatus and method for effectuating and affiliated marketing relationship, the subject matter and teachings of which are hereby incorporated by reference herein.

### FIELD OF THE INVENTION

The present invention pertains to an apparatus and a method for effectuating an affiliated marketing relationship and, in particular, to an apparatus and a method for effectuating, providing, and/or facilitating, an affiliated marketing relationship which can provide for the monitoring, the tracking, and/or the management of, marketing relationships, referral relationships, and/or other commerce-related affiliated marketing relationships and/or activities, in a network environment and/or otherwise.

### BACKGROUND OF THE INVENTION

The Internet and/or the World Wide Web has experienced tremendous growth in the number of users who access and “surf” same as well as in the various ways in which the Internet and/or the World Wide Web can be utilized by these individuals. The Internet and/or the World Wide Web is also quickly becoming a major platform and environment for conducting commercial transactions and other business dealings. There is no doubt that the Internet and/or the World Wide Web will continue to grow as a major transaction and communication platform and environment.

As is the case with conventional methods of doing business, conducting business on the Internet and/or the World Wide Web involves advertising one's goods and/or services as well as utilizing intermediaries, such as brokers and/or agents, to bring individuals and/or parties together. These intermediaries can facilitate introductions as well as referrals which can result in transactions, deals, purchases and/or sales, as well as any other events between the respective parties.

As the Internet and/or the World Wide Web will continue to prosper, the need to bring the services of the above-described intermediaries to same is also expected to grow. With this seemingly natural and/or expected progression, there is expected to be an ever-growing need to provide for the creation and/or management of affiliated marketing relationships. These affiliated marketing relationships can include, but not be limited to, directing and/or referring individuals to a merchant's web site via an advertisement and/or via any other appropriate practice or method, co-branding activities, brokering and/or brokerage activities, agency activities, and/or any other activities which can be performed by intermediaries in order to introduce parties to one another and/or in order to refer parties to one another.

As affiliated marketing activities become more and more prevalent, so to will the need to manage these affiliated marketing relationships which are and/or will be associated therewith. Issues such as determining and/or calculating commissions and/or referral fees as well as when commissions and/or referral fees are earned and by whom, will no doubt arise in the electronic environment of the Internet and/or the World Wide Web. Other issues, such as how commissions and/or referral fees can be paid to the party earning same, and/or how these transactions can be accounted for, are also expected to arise.

Other issues may arise or evolve regarding the facilitation and/or the creation of affiliated marketing relationships as well as how these relationships may be monitored and/or tracked so to as to ensure the integrity of same.

While prior art systems exist which appear to rely on the utilization of a central clearinghouse to perform and/or to provide various services for facilitating certain affiliated marketing relationships, these clearinghouses fall far too short of being able to satisfy the current and expected needs of the parties involved in the areas of commission and/or referral fee determination and/or calculation, commission and/or referral fee payment, financial account administration and/or management, financial account security, affiliated marketing relationship monitoring, affiliated marketing relationship creation, as well as others.

### SUMMARY OF THE INVENTION

The present invention overcomes the shortcomings of the prior art. The present invention provides an apparatus and a method for effectuating an affiliated marketing relationship and, in particular, the present invention provides an apparatus and a method for effectuating, for providing, and/or for facilitating, an affiliated marketing relationship which can provide for the monitoring, the tracking, and/or the management, of marketing relationships, referral relationships, and/or other commerce-related affiliated marketing relationships and/or activities. The apparatus and method of the present invention can also be utilized in a network environment and/or otherwise in any other suitable environment.

The present invention can provide an apparatus and a method for allowing entities of any kind or type to enter into affiliated marketing relationships, whereby one or more entities refers individuals and/or users to merchants or vendors in order to facilitate a sale and/or a transaction involving the goods and/or services which are provided by the merchant or vendor.

The present invention can also facilitate the data processing and/or other processing and/or communication activities between any of the respective parties for ensuring that a marketing affiliation satisfies and/or fulfills the needs and/or obligations of all of the parties involved in an affiliated marketing arrangement and/or relationship.

The apparatus and method of the present invention can also monitor and/or track an individual consumer's activities, including the web sites and/or links which the individual respectively visited, utilized, and/or navigated through, so as to be brought into contact with the merchant and/or vendor, and further, to monitor which web sites and/or links should be credited with facilitating a transaction and/or a consummated deal.

The apparatus can include a User computer, which can be associated with a User, in order to engage, locate, find, buy, purchase, and/or otherwise engage in commerce involving any goods and/or services which can be obtained via the apparatus. Any number of User computers can be utilized with the apparatus of the present invention.

The apparatus can also include a Content Provider computer, which can be associated with a Content Provider, for providing information and/or other content to a respective User, along with providing links to various merchants, sellers, vendors, marketers, and/or other parties and/or entities described herein. Any number of Content Provider computers can be utilized with the apparatus of the present invention.

The apparatus can also include a Merchant computer, which is associated with any of the merchants, sellers, vendors, marketers, and/or any other parties and/or entities, which sell or provide goods and/or services in commerce via the apparatus of the present invention. Any number of Merchant computers can be utilized with the apparatus of the present invention.

The apparatus can also include a central processing computer for providing services to any of the parties which utilize the present invention.

The various User computers, Content Provider computers, and Merchant computers, can engage in bi-directional communication with every other computer described herein. Each of the computers can include associated and/or suitable central processing units (CPUs), Random Access Memories (RAMs), Read Only Memories (ROMs), databases, user input devices, output devices, transmitters, receivers, and/or any other hardware and/or software which may be necessary and/or which may be desired in order to perform the operations and functionality described herein.

The apparatus and method of the present invention can be utilized so as to facilitate, an affiliated marketing relationship and/or program. A Content Provider's computer or web site can provide advertisements containing embedded links to a Merchant's computer or web site. When a User accesses the Content Provider's computer or web site, he or she can link to the Merchant's computer or web site via an advertisement banner, text, icon, logo, and/or other advertisement.

The link can be a direct link, or an indirect link, to the Merchant's computer or web site. Once a User clicks on or selects and advertisement, the User can be linked to the Merchant's computer or web site. During the linking process, data and/or information which identifies the User, the Content Provider and/or Content Provider computer or web site, and/or any other pertinent data and/or information, can be transferred to the Merchant computer or web site in order to identify the referring Content provider as well as the User, if desired.

If the User thereafter makes a purchase from, and/or enters into and/or completes a transaction with, the Merchant's computer or web site, the Merchant computer will determine and/or calculate a commission and/or referral fee which is due the referring Content Provider pursuant to an agreement between the respective parties and/or pursuant to industry practice(s).

The apparatus of the present invention can also be utilized to administer and/or to manage financial accounts for any one or more of the respective Merchants and/or Content Providers described herein. The apparatus can also administer and/or manage financial accounts for any one or more of the Users and/or the central processing computers described herein. The apparatus of the present invention can also facilitate and/or effect financial transfers between any of the financial accounts administered and/or managed by the apparatus and method of the present invention.

The apparatus of the present invention can also be utilized in conjunction with a central processing computer or clearinghouse computer. In this embodiment, the Merchant computer can transmit any and/or all transaction data and/or information described herein, such as commissions and/or referral fees due, and/or commissions and/or referral fees paid to, the Content Providers who or which utilize the apparatus of the present invention. The Merchant computer can also transmit data and/or information regarding the User, the Content Provider, the number of referrals obtained from a Content Provider and/or the number of referrals from the Content Provider which resulted in a sale or other consummated transaction.

The apparatus and method of the present invention can effectuate and/or facilitate affiliated marketing relationships between Content Providers and Merchants and can also be utilized to maintain records, which can be financial and/or non-financial records, for any of these respective parties.

The central processing computer can be utilized so as to provide a repository for advertisements and/or advertising information as well as for advertisement spaces and/or services and/or offerings of same and/or related information. The central processing computer can also be a repository for terms and/or conditions, for any of the herein-described advertisements, advertisement spaces, advertisement requests and/or advertisement offerings.

The central processing computer can also provide a repository for any market, market research, and/or other, data and/or information which can be utilized by any of the respective parties described herein and/or which can be utilized in order to allow any users of the apparatus of the present invention to find and/or identify a respective counterpart (i.e. a Merchant can find or identify a Content Provider who will agree to carry its advertisement, a Content Provider can find or identify a Merchant to which it can sell advertisement space, etc.).

The apparatus can also provide notification to any of the respective parties concerning the occurrence of certain pre-specified events which may be related to the affiliated marketing relationship and/or which could be useful in facilitating a new affiliated marketing relationship between any two or more parties.

Any and/or all of the data and/or information which can be stored in any of the computers described herein can be stored in real-time and/or otherwise. In a similar manner, any and/or all of the data and/or information which is transmitted between any of the computers described herein can also be transmitted in real-time and/or otherwise.

The apparatus of the present invention can also facilitate, and/or be utilized to conduct, the bidding for and/or the auctioning of advertisements and/or advertisement space or services. The apparatus can also facilitate the making of offers, counter-offers, and/or counter-counter offers in and for any bidding and/or auctioning scenario.

The apparatus and method of the present invention can be utilized in order to provide for and/or to effectuate an affiliated marketing relationship for the sale of any goods and/or services, tangible as well as intangible, which can or which may be the subject of commerce and/or which may be the subject of a transaction.

The apparatus of the present invention can also be programmed in order to automatically generate and/or transmit any of the e-mails, electronic message transmissions, electronic notification transmissions, telephone calls, pager transmission and/or messages, and/or any of the other communications, which are described herein, between any of the parties which utilize the present invention.

The present invention can also be utilized in conjunction with intelligent agents, software agents, mobile agents, and/or related technologies. The respective intelligent agent(s), software agent(s), or mobile agent(s), can be programmed and/or can be designed so as to act on behalf of the respective Users, Content Providers, Merchants, and/or central processing computer operators.

The apparatus can be utilized on, over, and/or in conjunction with, the Internet, the World Wide Web, and/or any other communication network or system.

The apparatus of the present invention, in any and/or all of the embodiments described herein, can also be programmed to be self-activating and/or activated automatically. The apparatus of the present invention can also be programmed in order to automatically generate and/or transmit any of the messages and/or notification signals which can be transmitted by, and/or which can be received by, any of the respective parties and/or computers described herein.

The present invention, in any and/or all of the herein-described embodiments, can also utilize electronic commerce technologies and/or security methods, techniques and technologies.

Accordingly, it is an object of the present invention to provide an apparatus and a method for effectuating an affiliated marketing relationship.

It is another object of the present invention to provide an apparatus and a method for effectuating, providing, and/or facilitating, an affiliated marketing relationship.

It is still another object of the present invention to provide an apparatus and a method for effectuating, providing, and/or facilitating, an affiliated marketing relationship, which can provide for the monitoring, the tracking, and/or the management, of marketing relationships, referral relationships, and/or any other commerce-related affiliated marketing relationship and/or activity.

It is yet another object of the present invention to provide an apparatus and a method for effectuating, providing, and/or facilitating, an affiliated marketing relationship which can provide for the monitoring, the tracking, and/or the management of, marketing relationships, referral relationships, and/or other commerce-related affiliated marketing relationships and/or activities, in a network environment and/or otherwise.

It is another object of the present invention to provide an apparatus and a method for effectuating an affiliated marketing relationship which can monitor and/or track an individuals activities.

It is still another object of the present invention to provide an apparatus and a method for effectuating an affiliated marketing relationship which can ascertain a computer, web site, and/or other entity, which referred an individual to a merchant computer or web site.

It is yet another object of the present invention to provide an apparatus and a method for effectuating an affiliated marketing relationship which can ascertain a computer, web site, and/or other entity, which referred an individual to a Merchant computer or web site in order to make a purchase and/or to engage in a transaction on a respective merchant computer or web site.

It is another object of the present invention to provide an apparatus and a method for effectuating an affiliated marketing relationship which can ascertain computers and/or web sites which an individual has visited, utilized, and/or navigated through.

It is still another object of the present invention to provide an apparatus and a method for effectuating an affiliated marketing relationship which can ascertain the identity of a transaction referring party and provide for an appropriate payment and/or credit of a corresponding commission and/or referral fee.

It is yet another object of the present invention to provide an apparatus and a method for effectuating an affiliated marketing relationship which can be utilized on, over, and/or in conjunction with, the Internet, the World Wide Web, and/or any other communication network or system.

It is another object of the present invention to provide an apparatus and a method for effectuating an affiliated marketing relationship which utilizes links, hyperlinks and/or linking and/or hyperlinking techniques, such as in conjunction with banner advertisements, icons, text, logos, highlighted text, etc. and/or any other entities or devices which contain and/or include embedded code which creates a link from one web site, host computer, or file, to another web site, host computer, or file.

It is still another object of the present invention to provide an apparatus and a method for effectuating an affiliated marketing relationship which can ascertain a last or referring Content Provider, Content Provider computer, network computer, and/or server computer.

It is yet another object of the present invention to provide an apparatus and a method for effectuating an affiliated marketing relationship which can facilitate advertising relationships.

It is another object of the present invention to provide an apparatus and a method for effectuating an affiliated marketing relationship which can maintain records, financial and/or non-financial, for any of the respective parties who or which utilize the present invention.

It is still another object of the present invention to provide an apparatus and a method for effectuating an affiliated marketing relationship which can provide information regarding the availability of advertisements and/or the availability of advertising space, and/or the expiration of advertisements as well as the expiration and/or the unavailability of advertising space.

It is yet another object of the present invention to provide an apparatus and a method for effectuating an affiliated marketing relationship which can provide a clearinghouse for the purchase and/or sale of advertisement space.

It is another object of the present invention to provide an apparatus and a method for effectuating an affiliated marketing relationship which can provide for the calculation of commissions and/or referral fees earned pursuant to an affiliated marketing relationship.

It is still another object of the present invention to provide an apparatus and a method for effectuating an affiliated marketing relationship which can provide for the calculation of commissions and/or referral fees earned pursuant to an affiliated marketing relationship which can also provide for the monitoring, the tracking, and/or the management of, affiliated marketing relationships, referral relationships, and/or other commerce-related relationships.

It is yet another object of the present invention to provide an apparatus and a method for effectuating an affiliated marketing relationship which can facilitate the downloading of an advertisement to a content providers computer or web site.

It is another object of the present invention to provide an apparatus and a method for effectuating an affiliated marketing relationship which can facilitate the downloading of an advertisement from a Merchant's computer or web site.

It is still another object of the present invention to provide an apparatus and a method for effectuating an affiliated marketing relationship which can facilitate the downloading of an advertisement from a central processing computer or web site or a clearinghouse computer or web site.

It is yet another object of the present invention to provide an apparatus and a method for effectuating an affiliated marketing relationship which can facilitate the auctioning off of, and/or the bidding for, any advertisements and/or advertising space.

It is another object of the present invention to provide an apparatus and a method for effectuating an affiliated marketing relationship which can facilitate the management of financial accounts for any of the respective parties to a relationship.

It is still another object of the present invention to provide an apparatus and a method for effectuating an affiliated marketing relationship which can facilitate and/or which can effectuate the payment of commissions and/or referral fees and/or any other fees, advertising fees, management fees, etc., and/or which can conduct any other financial transactions for, and/or on behalf of, any of the respective parties who utilize the present invention.

It is yet another object of the present invention to provide an apparatus and a method for effectuating an affiliated marketing relationship which provides market research data and/or information, and/or other marketing data and/or information, which can be utilized by various parties to locate counterparts to an affiliated marketing relationship or arrangement.

It is another object of the present invention to provide an apparatus and a method for provide affiliated marketing relationships which can be programmed to automatically generate and/or transmit electronic mail (e-mail) messages, electronic message transmissions, electronic notification transmissions, telephone calls, pager transmissions and/or messages, and/or any of the other communications, between any of the parties which utilize the present invention.

It is still another object of the present invention to provide an apparatus and a method for effectuating an affiliated marketing relationship which utilizes electronic commerce technologies and/or security methods, techniques and/or technologies.

It is yet another object of the present invention to provide an apparatus and a method for effectuating an affiliated marketing relationship which can be programmed to be self-activating and/or which can be activated automatically.

It is another object of the present invention to provide an apparatus and a method for effectuating an affiliated marketing relationship which can be utilized in conjunction with intelligent agents, mobile agents, and/or software agents.

It is still another object of the present invention to provide an apparatus and a method for effectuating an affiliated marketing relationship which can be utilized in conjunction with the advertising and/or sale of any goods and/or services which can be the subject matter of commerce and/or which can be involved, or be the subject of, a transaction.

Other objects and advantages of the present invention will be made apparent to those skilled in the art upon a review of the Description of the Preferred Embodiment taken in conjunction with the Drawings which follow.

### BRIEF DESCRIPTION OF THE DRAWINGS

In the Drawings:

FIG. 1 illustrates a preferred embodiment of the apparatus of the present invention, in block diagram form;

FIG. 2 illustrates another preferred embodiment of the apparatus of the present invention, in block diagram form; and

FIGS. 3A, 3B and 3C illustrate a preferred embodiment operation of the apparatus of FIG. 1, in flow diagram form.

### DESCRIPTION OF THE PREFERRED EMBODIMENT

The present invention pertains to an apparatus and a method for effectuating an affiliated marketing relationship. In particular, the present invention provides an apparatus and a method for effectuating, providing, and/or facilitating, an affiliated marketing relationship which can provide for the monitoring, the tracking, and/or the management, of marketing relationships, referral relationships, and/or other commerce-related and/or marketing relationships and/or activities. The apparatus and method of the present invention can be utilized in a network environment and/or otherwise in any other suitable environment.

The present invention provides an apparatus and a method for allowing parties and/or entities of any kind or type to enter into affiliated marketing relationships, whereby one or more parties and/or entities refers individuals and/or users to merchants or vendors in order to facilitate a sale of, and/or other transactions involving, goods and/or services which are offered by and/or provided by a merchant or vendor.

The present invention facilitates the data processing and/or other processing and/or communication activities for ensuring that an affiliated marketing relationship satisfies and/or fulfills the respective needs and/or obligations of the parties or entities thereto. In this manner, a content provider web site, or its operator, can receive compensation for referring an individual who purchases and/or who otherwise engages in a transaction, from or on the web site associated with a merchant, vendor, and/or other seller or provider of goods and/or services.

The apparatus and method of the present invention can provide for the monitoring and/or for the tracking of an individual consumer's activities, including the web sites and/or links which the individual visited, utilized, and/or navigated through, in his or her being linked to, or being brought into contact with, the merchant and/or vendor, thereby identifying the computers and/or web sites, and/or links, which are and/or which can be credited with facilitating the sale, the transaction, the deal, and/or any other activity for which the referring party, computer, and/or web site can earn, and/or be credited as earning, a commission and/or a referral fee.

This monitoring and/or tracking of referring parties, computers, and/or web sites, can also be performed for referrals which may have occurred at an earlier time, and/or at a point in time, removed from the time the respective purchase, transaction, deal, and/or other activity.

Applicant hereby incorporates by reference herein the subject matter and teachings of U.S. Provisional Patent Application Serial No. 60/178,867, filed Jan. 29, 2000, which teaches and discloses an apparatus and method for effectuating and affiliated marketing relationship.

As used herein, the terms “individual”, “user”, “customer”, “client”, and/or the plural of same, refer to any individuals, users, customers, clients, and/or other parties and/or entities, who or which utilize the apparatus and method of the present invention so as to locate, find, buy, or purchase any good(s) or service(s) via any the affiliated marketing relationship described herein.

As used herein, the terms “Web Site owner”, Site owner”, “Content Provider”, “Referring Site”, “Marketing site”, and/or the plural of same, refer to any web site owners, site owners, content providers, referring sites, marketing sites, and/or other parties and/or entities, who or which utilize the apparatus and method of the present invention in order to provide affiliated marketing links and/or referrals to any of the merchants, sellers, and/or vendors, described herein in order to effectuate any affiliated marketing model relationship described herein.

As used herein, the terms “merchant”, “seller”, “vendor”, “marketer”, or the plural of same, refers to any merchants, sellers, vendors, marketers, and/or other parties and/or entities who or which sell or market goods and/or services which are sold, leased, traded, and/or which can otherwise be the subject matter of, and/or be involved in, a transaction which results from any of the affiliated marketing relationships described herein.

In any and/or all of the embodiments described herein, commissions and/or referral fees can be earned by respective Content Providers, and/or other referring parties, for introductions and/or referrals which result in a sale, a purchase, the entering into a transaction between the respective parties, the completion of a transaction between the respective parties, the entering of a deal, the completion and/or consummation of a transaction and/or a deal, and/or for any other defined event.

Applicant hereby incorporates by reference herein the subject matter and teachings of the following U.S. Patents: U.S. Pat. No. 5,991,740 which teaches a data processing system for integrated tracking and management of commerce related activities on a public access network; U.S. Pat. No. 5,848,396 which teaches a method and apparatus for determining behavioral profile of a computer user; U.S. Pat. No. 5,537,314 which teaches a referral recognition system for an incentive award program; U.S. Pat. No. 5,692,206 which teaches a method and apparatus for automating the generation of a legal document; U.S. Pat. No. 5,708,780 which teaches an Internet server access control and monitoring systems; U.S. Pat. No. 5,712,979 which teaches a method and apparatus for attaching navigational history information to universal resource locator links on a world wide web page; U.S. Pat. No. 5,715,315 which teaches CATV systems; U.S. Pat. No. 5,724,424 which teaches digital active advertising; U.S. Pat. No. 5,903,830 which teaches a transaction security apparatus and method; and U.S. Pat. No. 5,878,337 which teaches a transaction security apparatus and method. The present invention, in any and/or all of the embodiments described herein, hereby incorporates the teachings of, and can utilize the teachings of, the above-identified U.S. Patents as well as improve upon the teachings of the above-identified U.S. Patents.

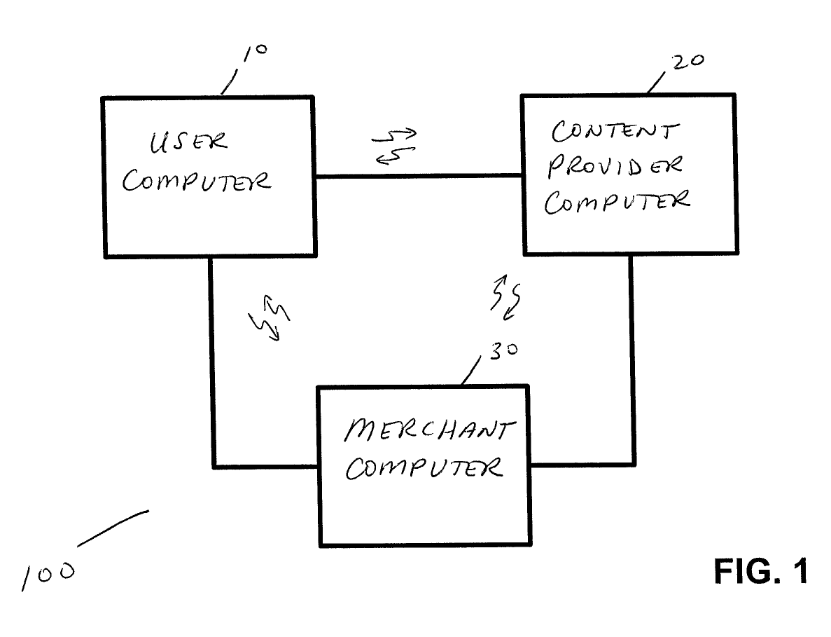

FIG. 1 illustrates a preferred embodiment of the apparatus of the present invention, which is designated generally by the reference numeral 100, in block diagram form. In the preferred embodiment of FIG. 1, the apparatus 100 includes a User computer 10 which is associated with a user of the apparatus and method of the present invention in order to engage, locate, find, buy, purchase, and/or otherwise engage in commerce, and/or in a transaction, involving any goods and/or services which can be obtained via the apparatus 100. Any number of User computers 10 can be utilized with the apparatus 100 of the present invention.

The apparatus 100 also includes a Content Provider computer 20 which is associated with a Content Provider for providing information and/or other content to a respective User along with providing links to various merchants, sellers, vendors, marketers, and/or other parties and/or entities described herein. Any number of Content Provider computers 20 can be utilized with the apparatus 100 of the present invention.

The apparatus 100 also includes a Merchant computer 30 which is associated with any of the merchants, sellers, vendors, marketers, and/or any other parties and/or entities, who or which sell or provide goods and/or services in commerce via the apparatus 100 of the present invention. Any number of Merchant computers 30 can be utilized with the apparatus 100 of the present invention.

The apparatus 100 can also include any number of central processing computers 40.

The various User computers 10, Content Provider computers 20, and Merchant computers 30, as well as the central processing computers 40 described hereinbelow, can engage in bi-directional communication with every other computer 10, 20, 30, and 40, on or over a suitable communication network. Each of the computers can include associated and/or suitable central processing units (CPUs), Random Access Memories (RAMs), Read Only Memories (ROMs), databases, user input devices, output devices, transmitters, receivers, and/or any other hardware and/or software which can be necessary and/or which can be desired in order to perform the operations and functionality described herein.

In the preferred embodiment, the apparatus 100 is utilized on, over, and/or in conjunction with, the Internet, the World Wide Web, a telephone communication network or system, a telecommunication network or system, a satellite communication network or system, a wireless communication network or system, a radio communication network or system, a digital satellite communication network or system, a personal communication services communication network or system, a global standard for mobile (GSM) communication network or system, a cable television network or system, a broadband communication network or system, and/or any other other appropriate communication network or system.

In the preferred embodiment, the User computer 10 can be any computer and/or communication device for allowing an individual to access the Internet, the World Wide Web, and/or any other computer or communication device which can be utilized in a communication network. The User computer 10 can be any one or more of a personal computer, a personal digital assistant, a telephone, a personal communications device, an interactive television, a television, a network computer, and/or any other appropriate communication device.

In the preferred embodiment, the Content Provider computers 20 and/or the Merchant computers 30, can also be any suitable or appropriate computer and/or communication device, and preferably can be a network computer, a server computer, and/or an Internet server computer, for performing the processing and functionality described herein.

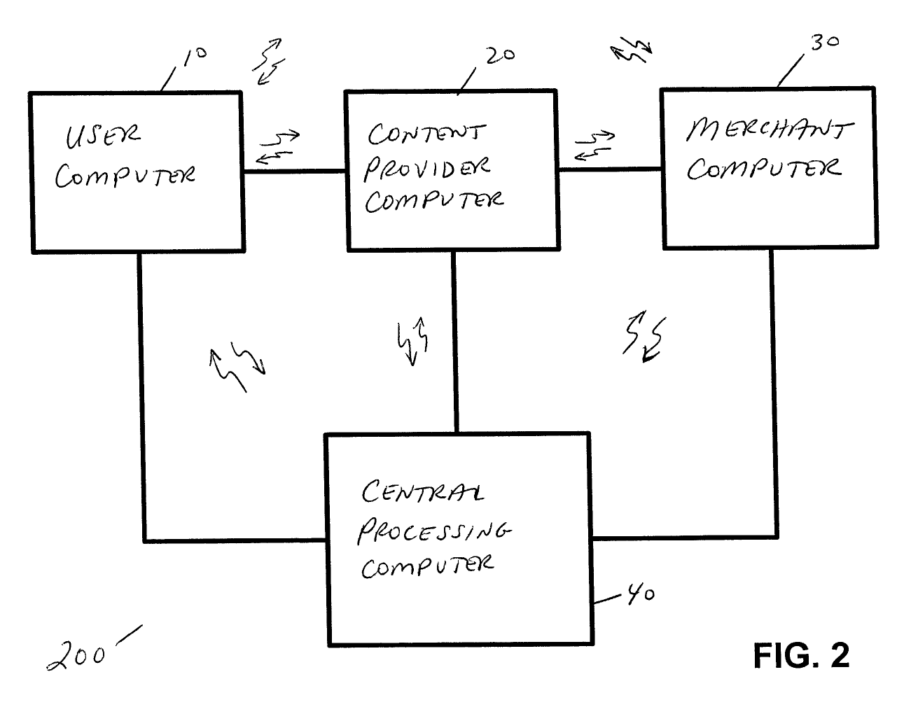

FIG. 2 illustrates another preferred embodiment of the apparatus of the present invention which is designated generally by the reference numeral 200. In the preferred embodiment of FIG. 2, the apparatus includes the User computer 10, the Content Provider computer 20 and the Merchant computer 30 described herein with reference to FIG. 1. The apparatus 200 can also include a Central Processing computer or Clearinghouse computer 40 (hereinafter “the central processing computer 40”). The central processing computer 40, as will be described herein, can be programmed to perform various processing routines for servicing any of the various and respective User computers 10, Content Provider computers 20, and/or Merchant computers 30, described herein.

In the preferred embodiments of the present invention, the various User computers 10, the Content provider computers 20, the Merchant computers 30, and/or the central processing computers 40, depending upon the preferred embodiment utilized, can be equipped any suitable hardware and/or software for performing their respective functions as described herein.

Each of various User computers 10, Content provider computers 20, Merchant computers 30, and/or central processing computers 40, can operate in accordance with the herein-described operations and methods of the present invention pursuant to software modules which contain instructions for allowing the respective computers to perform their respective operations and/or functionality as described herein. For example, the operation of a given preferred embodiment for utilizing the present invention can require that each of the various User computers 10, Content provider computers 20, Merchant computers 30, and/or central processing computers 40, perform certain respective functions. For example, the User computer(s) can be equipped with suitable browser software and/or with any other software needed to perform any of the functions described herein as being performed by the User computers 10.

The Content provider computer(s) 20 can be equipped with suitable software to present an advertisement, to provide a suitable link to a respective Merchant computer 30, and/or to monitor User activity and/or traffic on, and/or through, its respective web site. The Content Provider computer 20 can also be provided with any other software which may be needed to perform any of the functions described herein.

The Merchant computer(s) 30 can be equipped with suitable software to process transactions, to record User information, to ascertain and/or identify referring Content Providers and/or Content Provider computers 20, to calculate commissions and/or referral fees due the referring Content Providers, and/or to record and maintain transaction and/or referral records and/or information. The merchant computer 30 can also be provided with any other software which may be needed to perform any of the functions described herein.

The central processing computers 40 can similarly be equipped with any software needed in order to perform any of the functions described herein as being performed by the central processing computers and/or clearinghouse computers 40.

The present invention employs current Internet and/or World Wide Web links, hyperlinks, and/or linking or hyperlinking techniques, methods, and/or devices, such as those utilized in conjunction with banner advertisements, icon advertisements, logo advertisements, text advertisements, highlighted text advertisements, etc. and/or any other entities or devices which contain and/or include embedded code which creates a link from one web site, host computer, or file, to another web site, host computer, or file. In this manner a respective user can be linked, on, over, and/or across, the Internet and/or the World Wide Web, from one computer (such as, for example, a Content Provider computer 20) to another computer in the network (such as, for example, a Merchant computer 30).

The apparatus and method of the present invention can be utilized so as to facilitate affiliated marketing relationships and/or programs. In this regard, the present invention can provide an apparatus and/or system, and an associated method, wherein a Content Provider's computer 20 or web site can provide advertisements containing embedded links to a Merchant computer 30 or web site of a merchant selling and/or otherwise offering goods and/or services in commerce.

When a user accesses the Content Provider's computer 20 or web site, he or she can link to the Merchant's computer 30 or web site via an advertisement banner, text, icon, logo, and/or other advertisement. The link can be a direct link to the Merchant's computer 30 or web site. The link can also be an indirect link to the Merchant's computer 30 or web site which may direct the User through various parties, computers, and/or web sites, which may be affiliated with the respective Content Provider and/or with the respective Merchant. This indirect linking scenario can be the basis by which to facilitate other affiliated marketing relationships and/or co-branding relationships.

The user will then be linked to the Merchant's computer 30 or web site. During the linking process, data and/or information identifying the User, the Content Provider and/or Content Provider computer 20 or web site, and/or any other pertinent data and/or information, can be transferred to the Merchant computer 30 or web site. For example, the User can have a query string appended to his or her HTTP entry and/or other data and/or information entry. The User can also have a cookie or file placed on his or her User computer 10.

The Merchant computer 30 or web site can also query and/or “ping” the relevant network, or use any other techniques known by those skilled in the art, in order to ascertain the identity of the referring Content Provider computer, server, or web site, and/or so as to track the User's movement or navigation to the Merchant's computer 30 for ascertaining the last or referring Content Provider computer(s) 20, network computer and/or server computer.

If the user makes a purchase from, or engages in a transaction with, the Merchant's computer 30 or web site, the Merchant computer 30 can identify and notify the Content Provider's computer 20 of the referred sale or transaction and allocate a commission and/or referral fee to the Content Provider for the referral. The Merchant, via the Merchant computer 30 and/or otherwise, can also effect payment to the Content Provider and/or to the Content Provider computer 20.

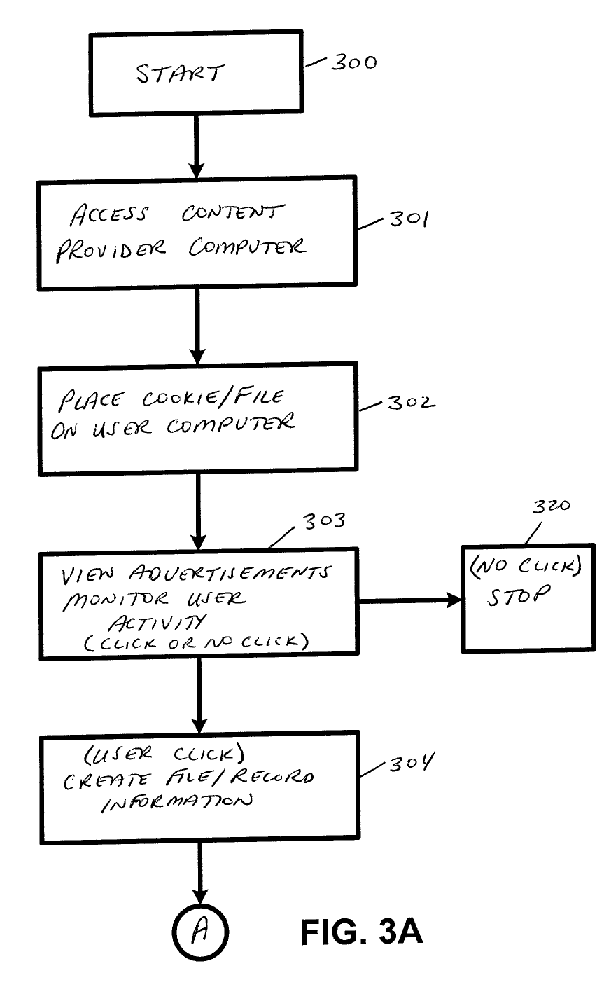

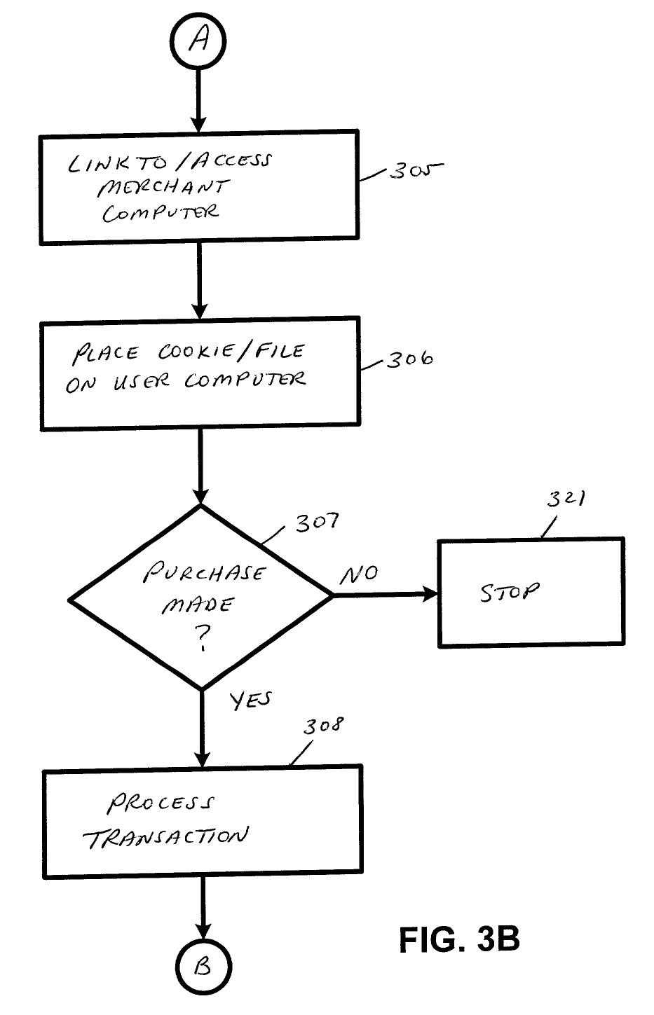

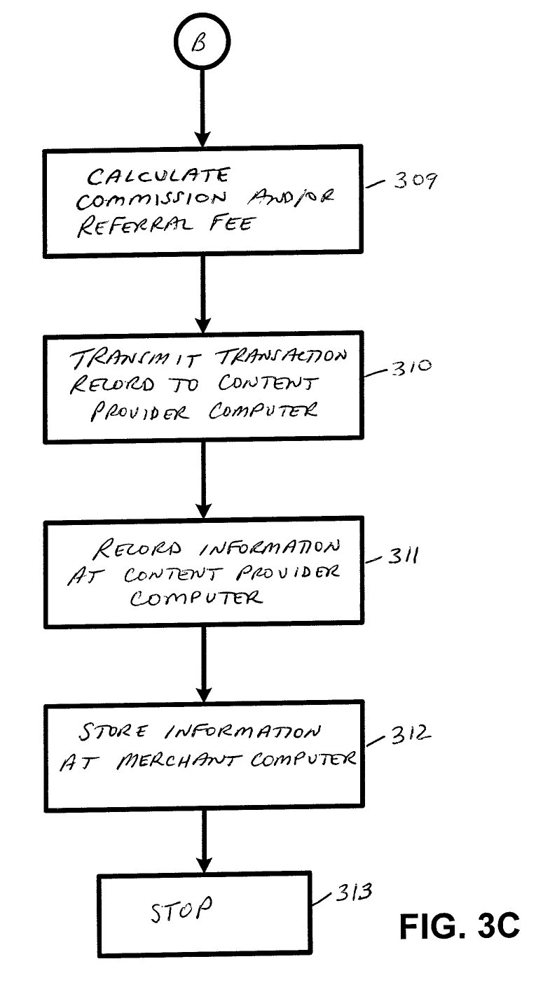

FIGS. 3A, 3B and 3C illustrate a preferred embodiment operation of the apparatus 100. With reference to FIGS. 3A, 3B and 3C, the operation of the apparatus 100 commences at step 300. At step 301, the user accesses the content Provider computer 20, via the User computer 10. The User computer 10, in the preferred embodiment, can be equipped with any appropriate Internet browser software for allowing the User to link to any of the various Content Provider computers 20 which can be accessed via the Internet, the World Wide Web, and/or the communication network on, and/or over, which the apparatus 100 is utilized.

The Content Provider computer 20 or web site can provide various information and/or services, including, but not limited to, Internet service provider information and/or services, Internet portal information and/or services, news information and/or services, auction services, financial information, sporting information, hobby information, special interest information, chat room services, e-mail services, and/or any other information and/or services which can be offered via a web site, network computer, or server computer, over the Internet, the World Wide Web, or other communication network.

The Content provider computer 20, in the preferred embodiment, also contains advertisements on the associated web site(s) and/or on any of the web page(s) associated with, and/or forming a portion of, same. The advertisements can be banner advertisements, text advertisements, logo advertisements, icon advertisements, and/or any other advertisements. In the preferred embodiment, the above-identified advertisements will contain embedded code which provides information for linking the User computer 10, via the Content Provider computer 20, to the Merchant computer 30 associated with the Merchant who has either placed the advertisement(s) and/or who is associated with the goods and/or services provider who or which offers the respective goods and/or services being advertised. An example scenario for illustrating the above is provided as follows.

A User, via a User computer 10, can access a Content Provider computer 20 which is associated with content provider ABC, Inc. ABC, Inc. provides news services. On the ABC web page, the User can see a banner advertisement, an icon advertisement, a logo advertisement, a text advertisement, and/or any other advertisement, for a product or service which can, for example, be an advertisement for clothing. The User can click on the respective advertisement and thereafter be linked to the Merchant computer 30 of the merchant advertising the clothing for sale.

At step 302, the Content Provider computer 20 can place a cookie or associated file on the User's computer 10 so as to track a subsequent interaction with, visit by, and/or activity with, the User. At step 303, the User can view the advertisements on the Content Provider's web site or web page(s). At step 303, the User can click on and/or select any of the advertisements. If, at step 303, the User leaves the Content provider's computer 20 or web site without clicking on or selecting an advertisement, the operation of the apparatus 100 will cease at step 320.

If, at step 303, the User clicks on or selects an advertisement, the Content Provider computer 20 will, at step 304, create a file for the User and record information regarding the User, the User ID, the date and time of the User access to the Content Provider computer 20, the time and date of any click on and/or any selection of any displayed advertisement, the Merchant associated with the advertisement, the site address of the merchant, and/or any other information which can be related to, and/or which can be of interest to the Content provider.

At step 305, the User computer 10 will then be linked to the Merchant computer 30 or web site, via the Internet, the World Wide Web, and/or any other communication network. At step 305, the Merchant computer 30 will ascertain the identity of the user and/or the User computer 10 and the Content Provider computer 20 or web site from which the user and User computer 10 was referred. Information regarding User ID, referring Content Provider, time and date of the visit to, and/or access to, the Merchant computer 30, can be transmitted and/or can be transferred to the Merchant computer 30 along with User source information and/or query string(s) and/or any other relevant data and/or information indicative of the communication and/or transfer, to the Merchant computer 30.

The User computer 10 can also have a query string(s) appended to its HTTP entry and/or other data and/or information entry. The User can also have a cookie or file placed on his or her User computer 10 by the merchant computer. The Merchant computer 30 or web site can query and/or “ping” the relevant network, or use any other techniques known by those skilled in the art, in order to ascertain the identity of the referring Content Provider computer, server, or web site, and/or so as to track the User's movement or navigation to the Merchant computer 30 for ascertaining the last or referring Content Provider computer(s) 20, network computer, and/or server computer.

If the user makes a purchase and/or enters into a transaction at the Merchant's computer 30 or web site, the Merchant computer 30 can identify and notify the Content Provider's computer 20 of the referred sale and allocate a commission and/or referral fee to the Content Provider for the referral.

At step 306, the Merchant computer 30 can place a cookie or associated file on the User's computer 10 so as to track a subsequent interaction with, visit by, and/or activity with, the User. At step 306, the User can purchase a good or service, and/or enter into a transaction with the Merchant, from the Merchant computer 30 or web site. At step 307, the Merchant computer 30 will determine whether the User made a purchase from, and/or entered into a transaction with, the Merchant. If, at step 307, it is determined that the User did not make a purchase from, and/or did not enter into a transaction, and/or did not complete a transaction, with the Merchant computer 30 or web site, the operation of the apparatus 100 will cease at step 321.

If, however, at step 307, it is determined that the User did make a purchase from, and/or that the User entered into a transaction with, and/or completed a transaction with, the Merchant computer 30 or web site, the Merchant will process the transaction, at step 308. The transaction and/or other event can be processed by the Merchant computer 30 and/or by any other computer associated with the Merchant computer 30 and/or the Merchant. Thereafter, at step 309, the Merchant computer 30 will generate and/or calculate a transaction commission and/or referral fee which is due to the referring Content Provider. The above-described commission and/or referral fee can be a predetermined fee or percentage of the transaction and/or can be agreed upon in advance by the respective Merchant and Content Provider. The commission and/or referral fee can also be determined and/or can be defined by industry practice(s).

Commissions and/or referral fees can be earned and/or can be due and payable to any referring parties, including brokers, agents, and/or other referring parties, pursuant to any agreed upon terms and/or conditions between the respective parties to the affiliated marketing relationship.

Commissions and/or referral fees can be due and/or payable to multiple content providers, such as co-brokering and/or joint-brokering arrangements, agency arrangements, and/or any other arrangement(s) and/or relationship(s) which provide for more than one individual and/or entity to earn and/or receive a commission and/or a referral fee for making an introduction and/or a referral which results in a sale, a transaction, and/or a completion of a transaction.

The Merchant computer 30 can include a database (not shown) which can store the specific terms and/or conditions of specific affiliate marketing relationships and/or agreements, including commissions and/or referral fees which are to be paid from the Merchant to the referring Content Provider(s). The agreements between the respective parties can include provisions for paying and/or splitting commissions and/or referral fees, to and/or between, respectively, multiple content providers for the respective parts or roles they play in effectuating a sale, a transaction and/or a completed transaction.

The Merchant computer 30 can calculate the respective commission(s) and/or referral fee(s) pursuant to the above-described specific agreements and/or pursuant to standard agreements which may be entered into between the respective Merchants and the respective Content Providers. Commissions and/or referral fees can also be defined by and/or can be dictated by industry practice(s).

The commissions and/or referral fees can also be a component of an advertising fee relationship and/or can be a component portion of a fixed fee/commission and/or referral relationship, and/or some combination and/or hybrid of both.

At step 309, the Merchant computer 30 can calculate the commission(s) and/or referral fee(s), due to the referring Content Provider or Content provider, whichever the case may be, by utilizing any of the herein-described data and/or information in any manner dictated by the respective affiliated marketing relationship or agreement which governs the relationship.

At step 310, the Merchant computer 30 can transmit a transaction record to the referring Content Provider computer 20 thereby providing the Content Provider and/or the Content Provider computer 20 with a transaction notification report which notifies the Content Provider that it has earned a commission and/or referral fee for referring the User to the Merchant computer 30 or web site, via the Merchant's advertisement located on the Content Provider's computer 20 or web site. In any and/or all of the embodiments described herein, any of the transaction notification reports described herein can be transmitted to the referring content provider(s) in real-time and/or otherwise.

In another preferred embodiment, the Merchant computer 30 can also transmit the transaction notification report to the central processing computer 40 which can monitor transactions which occur between any number of Merchants and/or Merchant computers 30 and/or Content Providers and/or Content provider computers 20.

At step 311, the transaction notification report can be utilized by the Content Provider for accounting and accounts receivable recording purposes. Thereafter, the Merchant computer 30 can, at step 312, store information regarding the User, the Content Provider, the number of referrals obtained from the Content Provider and the number of referrals from the Content Provider which resulted in a sale or other transaction. The operation of the apparatus 100 will thereafter cease at step 313.

In another preferred embodiment, the apparatus 100 can administer financial accounts for any one or more of the respective Merchants and/or Content Providers described herein. In this preferred embodiment, the respective Merchant computers 30 and/or Content Provider computers 20 can be linked to, and/or have associated therewith, financial accounts. In this regard, the respective operating software utilized in the Merchant computers 30 and/or in the Content Provider computers 20 can administer the respective financial accounts associated with the respective party. In this embodiment, the Merchant computer 30, upon generating the transaction notification report, can include, in the transaction notification report, a payment identifier, a credit card number or credit number, a debit card number or debit number, an electronic check, an electronic money order, a financial wire transfer, and/or any other electronic payment and/or payment medium.

Once received by the Content Provider computer 20, the electronic payment can be credited to the Content provider's financial account and be correspondingly debited from, and/or charged to, the Merchant's financial account.

In the above-described manner, the apparatus 100 can facilitate the calculation of commissions and/or referral fees in affiliated marketing relationships and can also facilitate the effecting of financial transactions corresponding to and/or in accordance with the affiliated marketing relationships.

In another preferred embodiment, the present invention can be utilized in conjunction with the central processing computer or clearinghouse computer 40 of FIG. 2. In this preferred embodiment, the Merchant computer 30 can transmit any and/or all transaction data and/or information described herein, such as commissions and/or referrals due, and/or to be paid to, the respective Content Providers, to the central processing computer 40. The Merchant computer 30 can also transmit data and/or information regarding the User, the Content Provider, the number of referrals obtained from a Content Provider and/or the number of referrals from the Content Provider which resulted in a sale or other transaction, to the central processing computer 40.

In the above-described manner, the apparatus and method of the present invention can facilitate affiliated marketing relationships between Content Providers and Merchants.

In another preferred embodiment, the apparatus and method of the present invention can be utilized in conjunction with the central processing computer 40 so as to facilitate the creation of advertising relationships between the various parties and/or for maintaining records, financial and/or non-financial, for any of these respective parties and/or the respective and/or resulting relationships.

The central processing computer 40 includes a database (not shown) which can store Merchant advertisements and/or advertising information. The merchant advertisement and/or advertising information can include advertisements which the Merchant wishes to offer to the various Content Providers. These advertisements and/or advertisement information can include advertisement modules which can contain banner, logo, icon, and/or text advertisement information along with embedded code(s) for providing links to, and/or for linking to, the respective Merchant computer 30 or web site. These advertisement modules can be downloaded from the central processing computer 40 to a Content provider computer 20, via the Internet, the World Wide Web, and/or other communication network, and can be placed on the Content Provider's computer 20 and/or web site.

The database can contain advertisements which are offered from the various Merchants. The database can also contain advertising space which is available for sale or rent by the various Content Providers. The database can also contain the terms or conditions, including but not limited to, payment amounts, and/or commissions and/or referral fees offered, for and/or associated with the various advertisements, advertisement terms and/or conditions, including but not limited to, fees, commissions and/or referral fees, associated with available advertising space, terms for automatic acceptance of the any of the herein-described advertisements and/or advertisement space, the number of visits and/or hits on an advertisement banner, logo, icon, and/or text, obtained by a Content Provider(s), the number of sales and/or completed transactions obtained from an advertisement in relation to the number of visits or hits for a particular advertisement and/or for a given Content Provider, the commissions and/or referral fees paid by a Merchant(s), the amount of commissions and/or referral fees paid to a Content Provider(s), transactions involving commissions and/or referral fees being earned by Content Providers as well as when these commissions and/or referral fees are paid.

The database can also contain data and/or information regarding the availability of advertisements and/or the availability of advertising space, and/or the expiration of advertisements as well as the expiration and/or the unavailability of advertising space.

The database can also contain contact information for any of the respective Merchants along with criteria and/or events, the occurrence of which they desire to be notified. These criteria, events and/or occurrences, can include, but not be limited to, the availability of advertising space by a certain Content Provider(s), changes in prices of advertising space, changes in terms and/or conditions for advertising space, the effected payment of a commission and/or referral fee to a Content Provider, and/or any other event(s) or occurrence(s) which may be of interest to a Merchant.

The database can also contain contact information for any of the respective Content Providers along with criteria and/or events, the occurrence of which they desire to be notified. These criteria, events and/or occurrences, can include, but not be limited to, a request for advertising space by a certain Merchant(s), changes in offered prices for advertising space, changes in terms and/or conditions for an advertising offering, a sale or transaction resulting in a commission and/or referral fee earned by a respective party, an effected payment, and/or a deposit, of any commission and/or referral fee to a respective party and/or into the respective party's financial account, and/or any other event(s) or occurrence(s) which may be of interest to a Content Provider.

The database can also contain contact information for any of the respective Users along with criteria and/or events, the occurrence of which they desire to be notified. These criteria, events and/or occurrences, can include, but not be limited to, the notification of a advertisement debut, the introduction of an advertisement and/or an advertising campaign by a specified Merchant or Merchants and/or for a specified good(s) and/or service(s), the offering of a specified good(s) and/or service(s) at a specified price(s) and/or under certain term(s) and/or conditions, changes in terms and/or conditions, and/or price(s) and/or offering(s) of a good(s) and/or service(s), and/or any other event and/or occurrence which may be of interest to a User.

The database can also include data and/or information concerning the past success rates for a particular advertisement(s), as well as success rates for particular Content Providers, and/or for particular Merchants. The database can also contain any other data and/or information for providing and/or for facilitating any of the functions and/or services described herein as being performed by the apparatus and method of the present invention, the User computers 10, the Content provider computers 20, the Merchant computers 30, and/or the central processing computers 40.

Any of the herein-described Merchants, Content Providers, Users and/or operators of the central processing computer 40, can enter requests for receiving notification for any pre-defined event or occurrence, and/or can enter any other criteria for receiving notification, into the central processing computer 40, via any of their respective computers. Notification requests can be effected in real-time and/or otherwise.

Any and/or all of the data and/or information which is stored in the database can be entered and/or can be updated in real-time and/or otherwise.

In any and/or all of the embodiments described herein, any and/or all of the data and/or information can be transmitted by and between any of the respective User computers 10, the Content Provider computers 20, the Merchant computers, and/or the central processing computers 40. These transmissions and/or communications which take place between any of the respective computers 10, 20, 30 and/or 40, can be transmitted and/or can occur in real-time and/or otherwise. Further, in any and/or all of the embodiments described herein, any of the described data and/or information which is described as being transmitted from, to, and/or between, any of the respective computers and/or parties, can be in the form of, or as part of electronic mail (e-mail) messages, electronic message transmissions, electronic notification transmissions, telephone calls, facsimile transmissions, beeper and/or pager transmissions and/or messages, and/or via any other mode of communication.

In any and/or all of the embodiments described herein, any of the data and/or information stored in the database of the central processing computer 40 can be accessed by any one or more of the respective Users and/or User computers 10, the Content Providers and/or Content Provider computers 20, and/or the Merchants and/or Merchant computers 30, in real-time and/or otherwise. Further, the purchase and/or sale of any of the herein-described advertisements can be performed, via the central processing computer 40, in real-time and/or otherwise.

In another preferred embodiment, any of the respective Merchant computers 30, Content Provider computers 20, and/or central processing computers 40, can provide electronic notification to the respective parties and/or entities, of deposits into, withdrawals from, and/or any other transactions involving, any of the financial accounts which are associated with any of the Merchants, Content Providers, and/or central processing computer operators, whether or not the respective financial accounts are administered and/or managed by the apparatus 100, 200, and/or any of the respective Merchant computers 30, Content provider computers 20, and/or central processing computers 40. A respective party can also access any of the respective Merchant computers 30, Content provider computers 20, and/or central processing computers 40, and program the respective computer(s) so as to restrict and/or limit account activity. Applicant hereby incorporates by reference herein the subject matter of U.S. Pat. No. 5,903,830 which teaches a transaction security apparatus and method. Applicant also incorporates by reference herein the subject matter of U.S. Pat. No. 5,878,337 which teaches a transaction security apparatus and method.

In another preferred embodiment, the apparatus 200 can provide a clearinghouse for Merchants desiring to obtain advertising space, an advertising banner, an advertising logo, an advertising icon, an advertising text, and/or any other advertising device and/or services. In this embodiment, the Merchant can query the database of the central processing computer 40, and/or the database(s) of any of the Content Provider computers 20, which can contain and/or store the same data and/or information as stored in the database of the central processing computer 40, and/or otherwise ascertain and/or review the availability of advertisement spaces and/or services, made available by and/or offered by various Content Providers.

The database can contain information concerning the advertisement space, the Content provider offering same, advertisement rates, commissions and/or referral fees, and/or other terms and conditions of the advertisement offerings. Thereafter, the Merchant can select and purchase any desired advertisement space and/or services from the respective Content Provider. Thereafter, the parties can contact one another, via information and/or links provided by the central processing computer 40 and/or otherwise. In another embodiment, the central processing computer 40 can generate and transmit an e-mail message to the respective Content Provider informing the Content provider that its advertisement space(s) has, and/or that its advertising services have, been purchased.

The Merchant's advertisement file can then be provided to the Content Provider for inclusion on its computer 20 or web site, and/or the advertisement file can be downloaded, via the Internet, the World Wide Web, and/or any other communication network, from the Merchant's computer 30 and/or from the central processing computer 40, if stored thereon.

In another preferred embodiment, Merchants can bid on advertisement space and/or services, and/or can make counteroffers to Content providers on or for advertised advertising space and/or services. In this embodiment, the respective Content Providers can auction advertisement space and/or services, and/or can make counter-counter offers to Merchants regarding same.

In another preferred embodiment, the apparatus 200 can provide a clearinghouse for Content Providers desiring to sell advertising space and/or services to Merchants. In this embodiment, the Content Provider can query the database of the central processing computer 40, and/or the database(s) of any of the Merchant computers 30 which can contain and/or store the same data and/or information as stored in the database of the central processing computer 40, and/or otherwise review requests for, and/or orders for advertisement space and/or services, which are placed by the various Merchants.

The database can contain information concerning the type of advertisement space or services desired, the Merchant requesting same, advertisement rates, commissions, and/or referral fees offered to be paid by the Merchant, and/or other terms and conditions of the advertisement request. Thereafter, the Content Provider can select the advertisement request or offer which it desires to accept and/or fulfill. Thereafter, the parties can contact one another, via information and/or links provided by the central processing computer 40 and/or otherwise. In another embodiment, the central processing computer 40 can generate and transmit an e-mail message to the respective Merchant informing the Merchant that a Content Provider has agreed to sell it or otherwise provide it with advertisement space and/or services.

The Merchant's advertisement file can then be provided to the Content Provider for inclusion on its computer 20 or web site, and/or the advertisement file can be downloaded, via the Internet, the World Wide Web, and/or any other communication network, from the Merchant's computer 30 and/or from the central processing computer 40, if stored thereon.

In another preferred embodiment, Content Providers can auction off advertisement space and/or services and/or make counteroffers to Merchants in response to offers for advertisement space and/or services. In this embodiment, the respective Merchants can bid for advertisement space and/or services, and/or make counter offers for same.

In any and/or all of the embodiments described herein, any of the data and/or information described as being stored in the database of the central processing computer 40 can be transmitted to the central processing computer 40 by any of the respective Content Provider computers 20 and/or Merchant computers 30. Once an affiliated marketing relationship is established, via the central processing computer 40 and/or otherwise, the apparatus and method of the present invention, as described with reference to FIG. 3, can be utilized in order to effectuate and/or facilitate the affiliated marketing relationship between the parties.

The apparatus and method of the present invention can be utilized in order to provide or effectuate affiliated marketing relations for the sale of any goods and/or services, tangible as well as intangible, which can and/or which may be the subject of commerce and/or of a transaction. These goods and/or services can include, but are not limited to, clothing, apparel, foods, sporting goods, books, toys, insurance products and services, real estate services, real estate, rental properties, real estate for sale, insurance products and services, health insurance products and services, life insurance products and services, disability insurance products and services, group insurance products and services, group health insurance products and services, group life insurance products and services, employee benefits products and services and/or packages , executive compensation products and services and/or packages, liability insurance products and services, casualty insurance products and services, property insurance products and services, malpractice insurance products and services, director and officer liability insurance products and services, automobile products and services, boat products and services, aircraft products and services, automobile parts products and services, automobile repair services, furniture products and services, vacation packages, vacation products and services airline products and services and/or airline tickets, rail tickets, boat tickets, medical products and services medical supplies, dental products and services and/or supplies, construction products and services and/or supplies, home improvement products and services and/or supplies, entertainment products and services and/or tickets, fitness and/or wellness products and services, exercise and/or recreational equipment, medical services, legal products and services, consulting products and services, profession and/or non-professional products and/or services of any kind or type, recruitment products or services, staffing products or services, secretarial services, contracting services, real estate products and services, accounting products or services, computer products and/or services, software products and/or services, education products and/or services, instructional products and/or services, communication products and/or services, telecommunication products and/or services, electrical utility products and/or services, telephone utility products and/or services, gas utility products and/or services, fuel utility products and/or services, wireless telephone products and/or services, management products and services, human resource management products and/or services, payroll processing products and/or services, financial transaction processing products and/or services, financial transaction notification and/or monitoring products and/or services, security products and/or services, home, premises, vehicle and/or personal security products and/or services, brokerage products and/or services, client relationship management products and/or services, consulting products and/or services, business products and/ore services, outsourcing products and/or services of any kind, insurance brokerage products and services, financial products and services, and/or any other kind of goods, products, and/or services, which can be sold, purchased, bartered and/or traded, in any transaction and/or which can be the subject of commerce and/or of a transaction of any kind.

In another preferred embodiment, the apparatus and method of the present invention can be utilized by advertisement agencies, and/or by brokers and/or agents of any kind. For example, the present invention can be utilized by insurance brokers or agents, stock or securities brokers or dealers, commodities brokers, dealers and/or agents, sales professionals, brokers, dealers, and/or agents, real estate brokers or agents, money and/or capital brokers, dealers, and/or agents, venture capital brokers and/or agents, and/or by any other individual, party, entity, broker, and/or agent, who or which can or may be compensated, at least in part, by commissions and/or referral fees, for the respective introductions and/or referral which they are in the business of making.

The present invention can also be utilized as a component part of customer relationship management tools and/or systems and/or software as well as in client relationship management tools, systems and/or software.

In any and/or all of the embodiments described herein, the apparatus and method of the present invention can be implemented with general purpose computers and/or network computers, and suitable communication equipment, along with respective modular software packages which facilitate the operation of each of the respective computers 10, 20, 30, and 40 in performing their respective functions and/or functionality.

In another preferred embodiment, as well as in any of the embodiments described herein, intelligent agents, software agents, mobile agents, and/or related technologies, can be utilized in conjunction with the present invention. The respective intelligent agent(s), software agent(s), mobile agent(s), (hereinafter referred to collectively as “intelligent agent” or “intelligent agents”) can be programmed and/or designed to act on behalf of the respective Users, Content Providers, Merchants, and/or central processing computer operators, and/or the respective computers 10, 20, 30 and/or 40.

The intelligent agent can act on behalf of the respective party or parties in various related transactions, interactions, and/or other activities, which are described as being performed herein and/or which may be incidental to and/or which may be related thereto. Therefore, the present invention also provides an agent-based apparatus and method for effectuating an affiliated marketing relationship.

Applicant hereby incorporates by reference herein the subject matter of the Agent Sourcebook, A Complete Guide to Desktop, Internet and Intranet Agents, by Alper Caglayan and Colin Harrison, Wiley Computer Publishing, 1997. Applicant also incorporates by reference herein the subject matter of Cool Intelligent Agents For The Net, by Leslie L. Lesnick with Ralph E. Moore, IDG Books Worldwide, Inc. 1997.

The apparatus of the present invention, in any and/or all of the embodiments described herein, can also be programmed to be self-activating and/or can be activated automatically.

The present invention provides an apparatus and a method for effectuating an affiliated marketing relationship and, in particular, to an apparatus and a method for providing, effectuating, and/or facilitating, affiliated marketing relationships and/or programs. The present invention also provides an apparatus and a method for calculating commissions and/or referral fees pursuant to the affiliated marketing relationship and can provide for the monitoring, the tracking, and/or the management of, affiliated marketing relationships, referral relationships, and/or other commerce and/or related relationships.

The present invention can also provide an apparatus and a method for effectuating an affiliated marketing relationship which can administer and/or manage financial accounts for and/or on behalf of any of the Content Providers, Merchants, Users and/or operators of the central processing computers.

The present invention can also facilitate the management of financial accounts and can also facilitate and/or effectuate the payment of, and/or the receipt of the payment of, commissions and/or referral fees and/or any other fees, advertising fees, management fees and/or can perform any other transactions, financial and/or otherwise, for, and/or on behalf of, any of the parties and/or entities described herein. The present invention can also be utilized to make a payment for, or on behalf of, any of the parties and/or entities described herein, as well as receive a payment for, or on behalf of, any of the parties and/or entities described herein.

In any and/or all of the embodiments described herein, any of the Content Provider computers 20, the Merchant computers 30, and/or the central processing computers 40, can process and/or effectuate financial transactions for, or on behalf of, any of the parties and/or entities described herein, make payments for, or on behalf of, any of the parties and/or entities described herein, and/or receive payments for, or on behalf of, any of the parties and/or entities described herein.

The present invention also provides an apparatus and a method for facilitating the buying and/or selling of advertisement space by and/or between any of the respective parties and/or entities described herein.

The present invention can also provide an apparatus and a method for receiving and/or for storing various affiliated marketing data and/or information which can provide valuable market, market research, and/or marketing, data and/or information, which can or may be utilized by various parties in finding and/or identifying suitable affiliated marketing counterparts and/or suitable affiliated marketing relationships. The market, market research, and/or marketing, data and/or information, can be utilized by a Merchant(s) to find and/or to identify a suitable Content Provider(s) and/or the present invention can be utilized by a Content Provider(s) so as to find and/or to identify a suitable Merchant(s).

The apparatus of the present invention can also be programmed in order to automatically generate and/or transmit any of the e-mails, electronic message transmissions, electronic notification transmissions, telephone calls, pager transmission and/or messages, and/or any of the other communications, which are described herein, between any of the parties which utilize the present invention.

The present invention, in any and/or all of the herein-described embodiments, can utilize electronic commerce technologies and security methods, techniques and technologies, as described and as set forth in Electronic Commerce Technical, Business, and Legal Issues, Nabil R. Adam, et al. Prentice Hall, 1999 and Web Security & Commerce, Simson Garfinkel with Gene Spafford, O'Reilly 1997, the subject matter of which are hereby incorporated by reference herein.

While the present invention has been described and illustrated in various preferred and alternate embodiments, such descriptions are merely illustrative of the present invention and are not to be construed to be limitations thereof. In this regard, the present invention encompasses any and all modifications, variations and/or alternate embodiments with the scope of the present invention being limited only by the claims which follow.

What is claimed is:

1. An apparatus for effectuating an affiliated marketing relationship, comprising:
a receiver for allowing a user to access said apparatus via a content provider computer;
a processor for processing a transaction entered into by the user and a merchant associated with said apparatus, wherein said processor identifies the content provider referring the user to said apparatus, and further wherein said processor calculates at least one of a commission and a referral fee due to the content provider, and further wherein said processor generates a transaction notification report containing information regarding the occurrence of the transaction and said at least one of a commission and a referral fee; and
a transmitter for transmitting said transaction notification report to a communication device associated with the content provider.

2. The apparatus of claim 1, wherein said transaction notification report further contains at least one of a payment identifier, a credit card number, a charge card number, a debit card number, financial account identification information, and wire transfer information, for effecting payment of said at least one of a commission and a referral fee to the content provider.

3. The apparatus of claim 1, wherein said apparatus administers a financial account for at least one of the merchant and the content provider.

4. The apparatus of claim 1, wherein said processor at least one of processes information to establish an affiliated marketing relationship between a merchant and a content provider and at least one of stores and processes information regarding an affiliated marketing relationship existing between the content provider and the merchant.

5. The apparatus of 1, wherein said processor at least one of processes a financial transaction for at least one of the merchant and the content provider, effectuates a payment by at least one of the merchant and the content provider, and effectuates a receipt of a payment for at least one of the merchant and the content provider.

6. The apparatus of claim 1, further comprising:
a memory device for storing at least one of information regarding an affiliated marketing relationship existing between the content provider and the merchant, information regarding advertisement space, and information regarding an advertisement.

7. The apparatus of claim 1, wherein said processor generates a financial transaction notification signal in response to a financial transaction which occurs on at least one of a content provider financial account and a merchant financial account.

8. The apparatus of claim 7, wherein said transmitter transmits said financial transaction notification signal to a communication device associated with the at least one of the merchant and the content provider.

9. The apparatus of claim 1, wherein said receiver receives at least one of a restriction and a limitation on a usage of at least one of a content provider financial account and a merchant financial account.

10. An apparatus for effectuating an affiliated marketing relationship, comprising:
a processor for processing a user event and for providing a link to a merchant computer;
a transmitter for allowing a user to access the merchant computer; and
a receiver for receiving a transaction notification report from the merchant computer, wherein said transaction notification report contains information regarding the occurrence of the transaction and at least one of a commission and a referral fee due to a content provider associated with said apparatus.

11. The apparatus of claim 10, wherein said transaction notification report includes at least one of a payment identifier, a credit card number, a charge card number, a debit card number, financial account identification information, and wire transfer information, for effecting payment of said at least one of a commission and a referral fee to the content provider.

12. The apparatus of claim 10, wherein said processor at least one of processes a financial transaction for at least one of the merchant and the content provider, effectuates a payment by at least one of the merchant and the content provider, and effectuates a receipt of a payment for at least one of the merchant and the content provider.

13. The apparatus of claim 10, further comprising:
a memory device for storing at least one of information regarding an affiliated marketing relationship existing between the content provider and the merchant, information regarding advertisement space, and information regarding an advertisement.

14. The apparatus of claim 10, wherein said processor generates a transaction notification signal in response to a transaction which occurs on a financial account associated with the at least one of the merchant and the content provider, and further wherein said transmitter transmits said transaction notification signal to a communication device associated with the at least one of the merchant and the content provider.

15. The apparatus of claim 10, wherein said receiver receives at least one of a restriction and a limitation on a usage of at least one of a content provider financial account and a merchant financial account.

16. A method for effectuating an affiliated marketing relationship, comprising:
allowing a user to access a merchant computer via a content provider computer;
processing a transaction entered into by the user and a merchant;
identifying the content provider referring the user to the merchant;
calculating at least one of a commission and a referral fee due to the content provider;
generating a transaction notification report containing information regarding the occurrence of the transaction and said at least one of a commission and a referral fee; and
transmitting said transaction notification report to a communication device associated with the content provider.

17. The method of claim 16, wherein said transaction notification report includes at least one of a payment identifier, a credit card number, a charge card number, a debit card number, financial account identification information, and wire transfer information, for effecting payment of said at least one of commission and referral fee to the content provider.

18. The method of claim 16, further comprising:
processing information to establish an affiliated marketing relationship between a merchant and a content provider.

19. The method of claim 16, further comprising:
processing a user event at a content provider computer;
providing a link to a merchant computer;
allowing a user to access the merchant computer; and
receiving a transaction notification report from the merchant computer, wherein said transaction notification report contains information regarding the occurrence of the transaction and at least one of a commission and a referral fee due to a content provider.

20. The method of claim 16, further comprising:
receiving at least one of a restriction and a limitation on a usage of at least one of a content provider financial account and a merchant financial account.
